(19) United States
(12) Patent Application Publication
(10) Pub. No.: US 2006/0294270 A1
(43) Pub. Date: Dec. 28, 2006

(54) Personal data storage and retrieval device

(76) Inventor: Steven N. Verona, Margate City, NJ (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/446,895

(22) Filed: Jun. 5, 2006

Related U.S. Application Data
(60) Provisional application No. 60/687,529, filed on Jun. 3, 2005.

(51) Int. Cl. G06F 13/38

(52) U.S. Cl. 710/62

(57) ABSTRACT

A secure and convenient data storage and retrieval system includes a housing in which a data storage device is mounted. The housing also has a wireless communications device so that input/output devices, such as desktop computers, cellular telephones and personal digital assistants can communicate with the data storage device. No human input can be made to the housing, but the input/output devices can store and retrieve data to and from the data storage device whenever the housing is in the range of the input/output devices. The communication is automatically established and the data can be accessed through the input/output devices. When the housing leaves the range of the input/output device, any data are erased from the memory of the input/output device.

### (e) BACKGROUND OF THE INVENTION

1. Field of the Invention

This invention relates generally to portable computer data storage devices.

2. Description of the Related Art

People have large amounts of data, of various degrees of sensitivity, stored on different electronic devices. This can include personal data, such as the contact information for friends and family, or personal financial information, and business data, such as corporate contact information, company financial information, etc. This data can be stored on different electronic devices, even though it is used by multiple devices, such as cellular telephones and personal digital assistants (PDAs) that both contain telephone numbers and calendars. Entering this data into several devices is time-consuming, and the process of updating the data in all such devices is prone to error and inconsistency between devices.

Security concerns in recent years have increased the desire to limit access to these large amounts of data to authorized users. But because convenience is so important, security is often lacking in practice. Thus, passwords are not changed frequently, making ready access to many people's sensitive data a common occurrence.

Therefore, the need exists for a device that increases security and convenient access to a person's data, but without an increase in effort required to access the data.

### (f) BRIEF SUMMARY OF THE INVENTION

The invention is a data storage and retrieval system. A data storage device is mounted in a housing that has no human-operable means on the housing for accessing the data storage device. This makes the housing compact and secure to prevent unauthorized access to the data storage device. A wireless transceiver, such as a wireless (e.g., Bluetooth) card, is mounted in the housing and connected to the data storage device so that other devices, such as a plurality of input/output devices physically separate from the housing, can access the data on the data storage device.

Each of the input/output devices has a wireless transceiver that is able to communicate wirelessly with the housing transceiver for retrieving and storing data in the data storage device. In a preferred embodiment, the data storage device is a hard drive that contains software, including an operating system, that causes the housing transceiver to communicate with the transceiver in each of the input/output devices when the housing and the respective input/output device come within range of their respective transceivers. This provides a seamless use of each device with the data on the data storage device so that when a user wearing or otherwise possessing the housing comes within range of the input/output device, the hardware in the housing begins to establish a protocol for the input/output device accessing the data on the data storage device. The types of input/output devices include, but are not limited to, desktop computers, portable computers, personal digital assistants, mobile telephones and portable music devices.

The invention also contemplates a method of data storage and retrieval. The method comprises disposing a data storage device in a housing, where the housing has no human-operable means for accessing the data storage device. This likewise restricts access to the data. Another step is the mounting of a wireless transceiver in the housing and connecting the transceiver to the data storage device so that the data on the data storage device can be accessed by the input/output device. The method also includes the step of disposing the housing within the range of a wireless transceiver in a first input/output device that is physically separate from the housing. The first input/output device is thus able to communicate wirelessly with the housing transceiver for retrieving and storing data in the data storage device. The first input/output device can thus retrieve data from the data storage device and store data in the first input/output device's memory, such as RAM. Once the first input/output device is taken outside of the range of the housing, the data is removed from the first input/output device's memory, and is only stored on the data storage device.

The method can include the step of positioning the housing within a range of a second input/output device that is physically separate from the housing. Because the second input/output device has a wireless transceiver that is able to communicate wirelessly with the housing transceiver, the second input/output device retrieves data from the data storage device and stores the data in the second input/output device's memory. When the second input/output device is taken outside of the range of the housing, the data is removed from the second input/output device's memory and stored only on the data storage device. The first and second input/output device can access the data on the data storage device at the same time.

With the invention, a user can take all of her data with her, and not risk the security problems associated with leaving the data elsewhere. Additionally, the user has access to all of her data wherever she is, without the need to manually upload or download it from one device to another, or update various devices.

### (g) BRIEF DESCRIPTION OF THE SEVERAL VIEWS OF THE DRAWINGS

FIG. 1 is a schematic view illustrating an embodiment of the invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### (h) DETAILED DESCRIPTION OF THE INVENTION

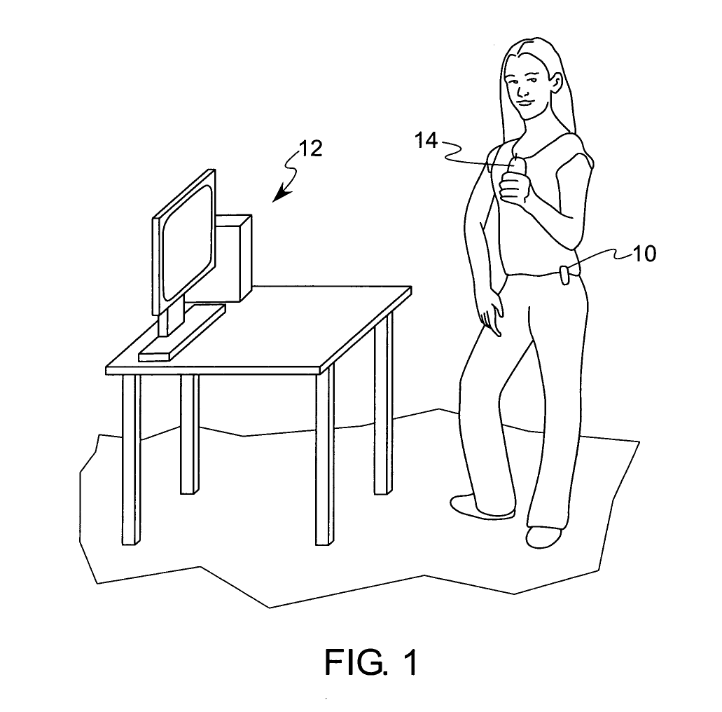

The invention is a system designed to store data, including application software, in a portable housing that stays on a person while he or she moves from place to place. In its simplest form, shown in FIG. 1, the invention includes a portable housing 10 containing a data storage device, such as a random access memory (RAM) chip, a secure digital card or a hard drive and a wireless transceiver, such as a Bluetooth card. The housing 10 preferably has a hard outer plastic or metal case to protect a hard disk drive (e.g., 100 GB), and communication hardware, and a one-eighth inch plug socket and/or an Ethernet socket.

The system also includes a plurality of input/output devices, such as a desktop computer 12 and mobile telephone 14. The Bluetooth card in the housing 10 is capable of communicating the data on the hard drive with, and receiving new data from, the input/output devices 12 and 14 either simultaneously or separately. Thus, the invention allows a user to store data in a compact housing that can be kept with the user at all times, thereby making the data accessible to the user at all times, but preventing access to the data to others when the user is absent.

The hard drive in the housing 10 is preferably combined with processing hardware and software, communication hardware and software, and an electrical power device, such as a battery, and is carried or worn on the person, such as on the belt in the manner of a pager or mobile phone, or in a pocket or purse. The hard drive contains an operating system that occupies minimal space, but cooperates with the hardware within the housing 10 and the input/output devices with which the hard drive communicates. The hard drive thus acts as a computer file server for the user by storing all types of computer files communicated to it from various input/output devices. Those files are then accessible whenever the user is in the range of the input/output devices. Thus, if the user wishes to operate a cellular phone, she simply turns on the cell phone within range of the housing 10, the cell phone's Bluetooth card establishes a communication protocol with the wireless card in the housing 10. The data that would normally be stored on the phone is instead on the hard drive, and accessible through the phone 14. Any new numbers or other data created through the phone is stored immediately on the hard drive in the housing 10.

When the phone is turned off or leaves the range of the housing 10, which means it leaves the range within which the phone 14 and the wireless card of the housing 10 can communicate, the data on the hard drive is no longer accessible to the phone 14, and, if it was temporarily stored in the phone's memory, may be automatically erased therefrom. This security feature ensures that the data on the input/output devices is only accessible when the housing 10 is in close proximity to the input/output devices.

The communication between the hard drive and the input/output devices operates seamlessly, preferably without any need for the user to manually act on either of the devices. The technology for establishing such seamless communications is conventional. Additionally, the communications between the housing 10 and any input/output device nearby, is made secure, such as by encrypting the transmissions. Thus, whenever the user and the housing 10 come within wireless communication range of a desktop computer, mobile phone, personal digital assistant (PDA) or any other input/output device permitted to communicate with the hard drive using one or more of the multitude of communication protocols, a communication protocol is established and the data on the hard drive become accessible to the input/output device. When the housing 10 leaves the range of each device, the communication ceases and any data stored in the input/output device's computer memory (RAM) may be deleted automatically by operation of software on the device. The hard drive can store contact information, music files, pictures, video, word processing files, passwords, and many other types of data, and those files can be read and written via communication hardware and software on an input and output device only when the user is present, regardless of the security needs for each type of file.

In its basic form, the housing 10 does not provide any human input or output capabilities; it is simply an application and/or data storage device that can communicate with multiple input/output devices. The housing 10 thus has no human-operable means for accessing or storing data on the hard drive, such as a keyboard, touch screen or other such structures that can be manipulated by human hands, fingers or hand-grippable instruments. This allows the hard drive to be accessed only through a physically separate, which means no wire or other tangible connector, input/output device that communicates wirelessly with the hardware in the housing 10. Of course, some input/output capability can be incorporated into the housing 10 to increase functionality for a particular user base, or to provide for entry and/or retrieval of the data. For example, the housing 10 can incorporate the hardware and software necessary to access audio files and output them to headphones. The housing may also include PDA functionality allowing the user to have a PDA that stores all other data files for the user. Furthermore, there can be one or a small number of buttons on the housing 10 that permit the user to reboot the hard drive, if necessary, or perform other relatively uncommon tasks to back up data or otherwise restore the hard drive to an operating condition.

It is known that Bluetooth can allow for wireless communication between the housing 10 and a cellular phone, laptop or PDA. Of course, an Ethernet or other physical wire can physically connect the housing 10 with the input/output device, but this is not preferred, other than for initial setup or data recovery, because it requires operator intervention that diminishes the seamless nature of the invention. Other forms of wireless communication can also be used, including, but not limited to, infrared transmission and other wireless technology. The hard drive thus centralizes a user's data and allows electronic “gadgets” to input data to the hard drive and receive/display data temporarily from the hard drive, rather than the gadgets each requiring stored data.

The portability of the device allows the user to access all of his own files wherever he desires, such as at home, at the office, in a car, etc. The portability allows for excellent security, because the user's files are with him at all times, rather than being left behind on other devices, such as at work on a desktop computer. Furthermore, the invention eliminates the need to synchronize data among several devices by storing the most up-to-date data on the hard drive and making it available to computers, cell phones, notebook/laptop computers, PDA's, etc.

As an example, contact information can be entered into the data storage device by any of a number of devices such as a laptop or PDA. Once entered, the contact information is accessible by computers, PDA's, cell phones, and any other device near the housing 10 that can communicate with the hard drive. This eliminates the need to duplicate the information for each device either manually or through a synchronization system. Furthermore, this makes upgrading the input/output device hardware and software virtually effortless, because the data on the hard drive is not affected in the upgrade. The data stored on the hard drive is simply communicated to the new device for temporary storage or display, and the data is accessible in the same way it was accessible to the old device.

Another embodiment of the invention has the minimal amount of hardware and software necessary for it to retain a large volume of data. For example, a person who possesses a desktop computer, laptop computer, PDA, cell phone, portable digital listening device (such as the IPOD brand device), automobile stereo with MP3 player and home stereo with MP3 player, can carry the housing 10 on his belt like a cellular phone. The housing 10 is similar in size to a cell phone, but has few or no external buttons, no display screen and no protruding antenna.

In the example, the owner of the housing 10 copies onto the hard drive all electronic data on his desktop, laptop, cell phone, PDA and music devices. This can be accomplished via a web browser, a customized graphical user interface on the devices, or any other means that will be apparent to the person having ordinary skill from the description herein. Copies can be retained on the individual devices, but for security purposes, all sensitive data should be moved to the hard drive of the housing 10. Once this has occurred, the person places the housing 10 on his belt and goes about his business. As he enters his office where his desktop computer sits on his desk, the Bluetooth card in the housing 10 comes within range of the desktop computer and begins to communicate with the desktop computer. Once the required protocol and security measures have been established, the data on the hard drive becomes available on the desktop computer, possibly by first requiring a password on some devices. Once the data becomes available, the user can add to or remove the files on the hard drive simply by using the desktop computer, and the hard drive is updated seamlessly. For example, the saved email the user has on his hard drive is available to him on the desktop computer. Email is accessed by the desktop, and written to the hard drive of the housing 10 either simultaneously or at predetermined intervals, so that upon leaving the desktop computer, the email data is no longer available on the desktop computer, but is updated automatically in the hard drive in the housing 10. It is also contemplated that the invention can create a mirror of the relevant data on the desktop computer, much like a RAID system works in conventional file servers, in order to back up the hard drive, if desired.

Once the user leaves the office and goes out of range of the desktop computer, the data on the hard drive is no longer available from the desktop computer. If the user takes the cell phone, PDA and laptop to an awaiting taxi, he can access the contact information on the hard drive via his cell phone and place a call. The user simply turns on the cell phone, and the cell phone and Bluetooth card establish a communication protocol. Then all of the data on the hard drive that is related to the cell phone appears on the cell phone, because that data, or a table of the data, can be loaded into the memory of the cell phone. Of course, the data displayed on the phone may remain in the hard drive and never be stored in the cell phone in order to increase security. It is contemplated that the data be limited to that which the input/output device is permitted to access, such as by establishing parameters and/or password limitations when the invention is first set up.

If a telephone number is added to the cell phone's address book via the cell phone input/output device, the updated address book data is stored on the hard drive via the communication means, and the hard drive retains that data. The cell phone may display the data, but it is desirable that the data be stored on the hard drive only. If the PDA is turned on, the PDA automatically begins to communicate with the Bluetooth card, and establishes a communication protocol. If a date is entered to the calendar of the PDA, the calendar data in the hard drive is updated at the time the data is entered into the PDA, and after turning off the PDA, the data is stored only on the hard drive of the housing 10.

Whether data is copied to the hard drive from the input/output device or written directly only to the hard drive can be determined based upon the user's preference. For example, the user may wish for all data to be saved on both the hard drive and the cell phone, but data on the desktop computer be retained only on the hard drive. Alternatively, the data can be backed up to the desktop computer, but not accessible unless the housing 10 is near to the desktop computer. Either mode is acceptable, depending upon the user's security and convenience demands.

If the user wishes to listen to music during the cab ride, he can turn on his portable digital listening device, which will communicate with the Bluetooth card of the housing 10, and all music files on the hard drive become available to the listening device. The same can occur if the user arrives at his home, because the home stereo can access the music files in the hard drive, as can the stereo in his automobile. And upon arriving at home and turning on the laptop computer, a communication link is established between the hardware in the housing 10 and the laptop, permitting the user to access all of the files on the hard drive through the laptop input/output device.

It will become apparent that all data that the user of the housing 10 has on the hard drive of the housing 10 is made available to him through input/output devices wherever the housing 10 is present, but not where the housing 10 is absent. This system keeps the data updated wherever the user is present, and as secure as possible where he is absent, because the data is always on the user's person, and not elsewhere. This system also operates seamlessly, because all input/output devices where the user is present are automatically updated if the user has established an updating process. Thus, upgrading the hardware of any of the input/output devices can be accomplished with no loss of access to data. Of course, updating of the data in the input/output devices can occur by requiring the user to request access to the data, which may be desirable to improve security.

While certain preferred embodiments of the present invention have been disclosed in detail, it is to be understood that various modifications may be adopted without departing from the spirit of the invention or scope of the following claims.

1. A data storage and retrieval system comprising:
(a) a data storage device in a housing, the housing having no human-operable means on the housing for accessing the data storage device;
(b) a wireless transceiver in the housing connected to the data storage device;
(c) a plurality of input/output devices physically separate from the housing, each of said devices having wireless transceivers that are able to communicate wirelessly with the housing transceiver for retrieving and storing data in the data storage device.

2. The system in accordance with claim 1, wherein the data storage device contains software that causes the housing transceiver to communicate with the transceiver in each of said input/output devices when the housing and the respective input/output device come within range of their respective transceivers.

3. The system in accordance with claim 2, wherein the data storage device is a hard drive.

4. The system in accordance with claim 2, wherein the data storage device is random access memory.

5. The system in accordance with claim 2, wherein the wireless transceiver in the housing is a wireless card.

6. The system in accordance with claim 2, wherein the plurality of input/output devices is selected from the group of a desktop computer, portable computer, personal digital assistant, mobile telephone and portable music device.

7. A method of data storage and retrieval comprising:
(a) mounting a data storage device in a housing, the housing having no human-operable means on the housing for accessing the data storage device;
(b) mounting a wireless transceiver in the housing and connecting the transceiver to the data storage device;
(c) disposing the housing within a range of a first input/output device that is physically separate from the housing, said first input/output device having a wireless transceiver that is able to communicate wirelessly with the housing transceiver when the housing is within the range for retrieving and storing data in the data storage device; and
(d) the first input/output device retrieving data from the data storage device

8. The method in accordance with claim 7, further comprising:
(a) storing said data in the first input/output device's memory;
(b) disposing the first input/output device outside of the range of the housing; and
(c) removing the data from the first input/output device's memory.

9. The method in accordance with claim 8, further comprising:
(a) disposing the housing within a range of a second input/output device that is physically separate from the housing, said second input/output device having a wireless transceiver that is able to communicate wirelessly with the housing transceiver when the housing is within the range for retrieving and storing data in the data storage device;
(b) the second input/output device retrieving data from the data storage device and storing said data in the second input/output device's memory;
(c) disposing the second input/output device outside of the range of the housing; and
(d) removing the data from the second input/output device's memory.
